(19) United States
(12) Patent Application Publication
(10) Pub. No.: US 2023/0160580 A1
(43) Pub. Date: May 25, 2023

(54) DEVICE FOR HEATING AND/OR COOKING FOOD

(71) Applicant: REAMOTION GMBH, Delmenhorst (DE)

(72) Inventor: Emilio REALES BERTOMEO, Delmenhorst (DE)

(21) Appl. No.: 16/499,161

(22) PCT Filed: Mar. 29, 2018
(86) PCT No.: PCT/EP2018/058129

§ 371 Date: Jan. 8, 2021

(30) Foreign Application Priority Data
Mar. 31, 2017 (DE) 20 2017 101 922.5

(51) Int. Cl. F24C 15/20; F23J 15/08; A47J 36/32; A47J 36/38; A47J 36/36; A47J 37/04; A47J 37/06; B01D 53/32

(52) U.S. Cl. CPC F24C 15/20; F23J 15/08; A47J 36/32; A47J 36/38; A47J 36/36; A47J 37/047; A47J 37/0629; A47J 37/0688; B01D 53/32; F23J 2219/201

(57) ABSTRACT

An apparatus for heating and/or cooking food is described. The apparatus includes an appliance housing with at least one accommodating device. The accommodating device has one or more accommodating compartments accessible by way of at least one opening in the appliance housing, and an accommodating container for the food which communicates with the respective accommodating compartment and can be inserted into and removed from the accommodating compartment. The apparatus also includes a heating device associated with the accommodating device and having one or more heating elements. The accommodating container has a closure portion for sealingly closing the respective accommodating compartment and an outwardly substantially closed cooking chamber for the food to be heated.

The invention concerns an apparatus for heating and/or cooking foodstuffs, in particular meat products and/or frozen products, comprising an appliance housing with at least one accommodating device, wherein the accommodating device has one or more accommodating compartments which are accessible by way of at least one opening in the appliance housing, and an accommodating container for the foodstuff which communicates with the respective accommodating compartment and can be inserted into and removed from the accommodating compartment, and a heating device associated with the accommodating device and having one or more heating elements.

In the preparation of foodstuffs in the fast food sector inter alia meat products like sausages or burgers are prepared for consumption by means of grill or cooking units and frozen products like for example French fries or croquettes are prepared using an open fryer. In the usual preparation method, by virtue of the kind of preparation involved, typically fat-bearing and odorous vapors are produced. In the field of fast-food restaurants and snack bars the attempt is made by means of complicated suction removal and filter installations to carry away or bind the fat-bearing vapors and odors in order to minimize the pollution due to the vapors and odors which occur in the preparation of the foodstuffs.

In addition the grill and cooking devices used in fast-food restaurants and snack bars as well as the fryers are to be permanently kept at a given uniform temperature level in order to be able to ensure suitable fast preparation. Keeping the preparation apparatuses at the necessary temperature however results in a high level of energy consumption. In addition the preparation of foodstuffs with usually known appliances for heating and/or cooking foodstuffs requires constant supervision or checking by the operating staff. That is necessary in order to ensure optimum quality in the preparation of the foodstuffs.

DE 20 2014 005 299 U1 discloses for example a cooking apparatus of the above-indicated general kind. The apparatus for heating and/or cooking foodstuffs has an accommodating device for the preparation of meat products and an accommodation device for the preparation of frozen products. The accommodating devices are arranged one above the other within the appliance housing, wherein a hot air flow for uniform cooking of the foodstuffs is passed through the apparatus in order to be able to implement uniform heating and/or cooking of the foodstuffs to be prepared in the accommodating devices. The energy consumption with that kind of preparation is admittedly reduced but is still comparatively high as the air flow which is passed through the apparatus is to be constantly held at a predetermined temperature level. In addition with the known apparatus it is nonetheless impossible to entirely prevent fat-bearing and odor-intensive vapors from issuing outwardly from the known apparatus when the prepared products are taken out.

Therefore the object of the invention is to provide an apparatus for heating and/or cooking foodstuffs, which permits simple and careful preparation of foodstuffs with a reduced level of energy consumption and with considerable avoidance of smells.

In an apparatus for heating and/or cooking foodstuffs of the above-indicated kind the object of the invention is achieved with the features of claim 1. In particular the accommodating container has a closure portion for sealingly closing the respective accommodating compartment so that an outwardly substantially closed cooking chamber for the foodstuff to be heated is provided during the preparation process.

The invention is based on the realization that, by means of a closed-off cooking chamber, the unwanted escape of heat which is usually to be used for preparation of the foodstuffs is avoided. The heat generated thus remains enclosed within the cooking chamber, whereby the energy consumption for producing and maintaining the required cooking temperature within the cooking chamber can be markedly reduced. In addition the closed configuration of the cooking chamber provides that any fat-bearing and smelly vapors do not issue from the cooking chamber during the cooking operation. This therefore counteracts pollution of the ambient air so that the smells in the preparation of foodstuffs by means of the preparation apparatus according to the invention can fundamentally be reduced. In addition it is possible to dispense with the use of fats and oils as temperature-generating substances within the cooking chambers according to the invention so that the odor pollution can be kept as low as possible from the outset. The closure portion serving to close the opening in the appliance housing, on the accommodating container or containers, can preferably be brought into contact with wall regions of the appliance housing, that delimit the opening for the accommodating containers. For preferably hermetic closure it is preferred that a sealing element having elastic properties is to be arranged on the closure portion, like for example a sealing lip, with which the issue of heat or vapors from the cooking chamber is further impeded.

A preferred configuration of the apparatus according to the invention is distinguished by a plurality of accommodating devices for different foodstuffs, wherein a first accommodating device is adapted for heating/cooking meat products and a second accommodating device is adapted for heating/cooking frozen products, wherein the accommodating devices preferably respectively have accommodating compartments with an insertion direction extending substantially in a horizontal direction. By means of the preferably plurality of accommodating device a larger amount of a foodstuff and also different foodstuffs, depending on the respective design configuration of the accommodating device, can be prepared at the same time by means of the apparatus according to the invention. In an embodiment of the invention the accommodating devices have a horizontal insertion and/or removal direction. This provides that the heat generated by the heating device in the accommodating compartment is held within the accommodating compartment by the upper closed wall region. Neither heat nor vapors or smells can issue by way of the closed upper wall at the respective accommodating devices for the foodstuffs to be prepared. In this way the retention of heat within the cooking chamber or chambers is improved.

Preferably the first accommodating device has two accommodating compartments with insertion cassettes which can be inserted into and removed from the accommodating compartments and having respective accommodating means for a plurality of meat products and/or the second accommodating device has an accommodating compartment with a drum which can be inserted into and removed from the accommodating compartment for the foodstuff to be heated, wherein the drum is preferably received rotatably within the accommodating compartment. Depending on the respective nature of the foodstuffs to be heated the insertion cassettes have accommodating means suitably adapted to the form of the foodstuff. The accommodating means of the insertion cassette is preferably delimited by a receiving grid for the foodstuff or the foodstuffs to be heated. Preferably the insertion cassette is of such a design that the meat products like for example sausages which are to be preferably prepared therein are arranged in a perpendicular orientation in a row one behind the other in the accommodating means of the insertion cassette. The second accommodating device includes a drum for the foodstuffs which are in particular in the form of frozen products. For heating or cooking purposes the foodstuffs like for example French fries or croquettes are put into the drum. The drum is then inserted into the accommodating compartment of the second accommodating device, with the drum preferably being mounted rotatably about its longitudinal axis. During preparation of the frozen products the drum is caused to rotate, whereby the aim is to ensure that the foodstuffs to be heated are heated or cooked uniformly with the heat generated within the accommodating compartment by the heating device.

In a particularly preferred embodiment of the present invention which at the same time also concerns a separate aspect of the invention the apparatus according to the invention is distinguished by at least one discharge air passage which can be coupled in fluid-conducting relationship to an accommodating device and having an actuable fan for discharge of the preparation vapors produced during the cooking process in the form of discharge air from the cooking chamber after preparation of the foodstuffs, wherein preferably a plasma chamber for cleaning the discharge air from the cooking chamber is arranged within the discharge air passage. The invention is based on the realization that, by means of an discharge air passage, the fat-bearing and smelly vapors which occur upon preparation of the foodstuffs can be discharged directly following preparation from the cooking chamber so that when the cooking chambers are opened no preparation vapors flow out into the ambient atmosphere by way of the insertion openings by virtue of removal of the accommodating containers which were inserted into the respective accommodating compartments.

In order in accordance with the first aspect of the present invention to keep the heat within the cooking chambers during preparation of the foodstuffs the discharge air passage can be coupled in fluid-conducting relationship to the respective accommodating compartment of the accommodating device, as required. In the present case that means that the discharge air passage does not have a fluid-conducting communication with the respective accommodating compartment during preparation of the foodstuffs or such communication is interrupted. It is only with the conclusion of the preparation or cooking process that the fluid-conducting communication is made between the respective accommodating compartment and the discharge air passage. Furthermore disposed within the discharge air passage is a preferably actuable fan which is activated when the fluid-conducting connection is made between the discharge air passage and the accommodating compartment and the vapors are removed from the respective cooking chamber. If the fluid-conducting communication is interrupted then the fan is also switched off again.

In a preferred configuration of the invention arranged within the discharge air passage is a plasma chamber for cleaning the discharge air which comes out of the accommodating compartment or compartments. Preferably ionization of the discharge air passed through the plasma chamber is effected within the plasma chamber. Discharge air which is introduced into the plasma chamber and in particular constituents contained therein like very small fat particles or oils are converted in such a way that principally oxygen, carbon dioxide and water vapor form constituents of the treated discharge air in the discharge air passage passage downstream of the plasma chamber. By means of the plasma chamber which is used in the discharge air passage the discharge air is cleaned of up to 80% of the unwanted constituents contained therein, preferably up to 98% of the unwanted constituents. The discharge air leaving the appliance housing is thus almost completely cleaned whereby pollution of the ambient air is reduced to a minimum.

Preferably associated with the discharge air passage is a device for controlling at least the discharge air to be discharged from the accommodating compartment or compartments. By means of the device for controlling the discharge air, preferably in the simplest design configuration of the control device for the discharge air, the mass flow flowing through the discharge air passage is adapted by changing the fan speed. Another configuration of the invention provides that the control device for the discharge air, after preparation of the foodstuffs has occurred in the respective accommodating compartment, produces a fluid-conducting communication between the discharge air passage and the accommodating compartment or compartments. In a further embodiment the control device is so designed that the various accommodating compartments of first and second accommodating devices for the foodstuffs are brought into fluid-conducting communication with the discharge air passage individually or also jointly, or the fluid-conducting communication is interrupted again before the beginning of the next cooking operation, into one of the accommodating devices. In an embodiment, the device for controlling the discharge air ensures that the accommodating compartments for the accommodating containers to be inserted therein, during the process of preparing the foodstuffs, for constituting the outwardly closed cooking chamber, are sealingly closed using suitable separation or closure means in the connecting region with the discharge air passage.

A development of the apparatus according to the invention provides that the device for controlling the discharge air has at least one actuable discharge air flap, by means of which the at least one outlet opening connected to the discharge air passage on the accommodating compartment can be opened and closed, and preferably has an actuable feed air flap, by means of which the at least one inlet opening connected to the environment by way of a feed air passage on the accommodating compartment can be opened for the introduction of fresh air into the accommodating compartment and can be closed. The provision of a discharge air flap and a feed air flap at a respective accommodating compartment of the first and/or second accommodating device permits simple control of discharge of the preparation vapors which occur during the cooking process, from the accommodating compartment, or blocking of the communication with the discharge air passage. A feed of fresh air into the interior of the accommodating compartment is achieved by way of the inlet opening which can be opened or closed by means of the feed air flap, whereby air exchange within the accommodating compartment is promoted. A reduced pressure which has a detrimental effect in the accommodating compartment is avoided thereby. Preferably the accommodating compartments of the first and second accommodating devices, for the foodstuffs to be heated or cooked, have respective separately actuable discharge air flaps and/or feed air flaps. Furthermore in a preferred configuration of the invention the first accommodating device has respective individually actuable discharge air and feed air flaps for the two accommodating compartments which are preferably arranged in mutually juxtaposed relationship. The discharge air and feed air flaps are preferably operable or actuable by way of suitable drive or adjusting means, by way of which the discharge air and/or feed air flaps can be moved into their open position or their closed position at the corresponding outlet or inlet opening respectively on the accommodating compartment.

Preferably arranged within the discharge air passage is an air turbulence means connected upstream of the plasma chamber for mixing the discharge air and preferably for adding ambient air from the housing interior, wherein preferably provided in the wall of the appliance housing is at least one fan for introducing ambient air into the appliance housing. In an embodiment, by means of the air turbulence means arranged within the discharge air passage, the discharge air removed from the accommodating compartments of the apparatus is put into a state of turbulence in the discharge air passage in such a way that a uniform temperature level prevails over the cross-section of the discharge air passage. In addition temperatures of over 50° C., preferably over 45° C., within the discharge air passage should be avoided before the discharge air passes into the plasma chamber in order to ensure a high degree of efficiency of the plasma chamber disposed in the discharge air passage. Preferably the plasma chamber has its highest level of efficiency when the discharge air introduced into the plasma chamber is at a temperature of at least 45° C.

Preferably in an embodiment of the invention the air turbulence means is adapted to suck ambient air out of the interior of the housing into the discharge air passage by way of a kind of bypass passage, whereby it is possible to ensure that the temperature within the discharge air passage does not exceed the critical highest temperature of 45° C. Mixing of the ambient air from the housing interior is preferably effected by way of control of the pressure in the interior of the appliance housing. Preferably one or more fans are arranged for introducing ambient air into the housing interior at the appliance housing. The fans blow fresh air into the appliance housing in a controlled fashion. The greater the volume flow which is blown into the appliance housing by means of the fans, the correspondingly less is the pressure difference in the region of the bypass passages at the air turbulence means, which passages preferably extend radially relative to the discharge passage, whereby more ambient air passes out of the housing interior into the discharge air passage. If the volume flow introduced by the fans in the appliance housing is reduced a greater proportion of discharge air is discharged from the accommodating compartments of the accommodating device so that then the proportion of discharge air from the accommodating compartments in the discharge air passage is increased. The air turbulence means disposed within the discharge air passage includes at least one guide device having a plurality of guide plates which project into the flow path of the discharge air passage. The discharge air passage is preferably of a rectangular cross-section, with the air turbulence means being of a circular cross-section which is reduced in comparison with the cross-section of the discharge air passage. In that way, a flow acceleration effect occurs in the region of the air turbulence means. Preferably provided at the side walls of the rectangular discharge air passage are through openings in the form of bypass passages, which extend radially relative to the longitudinal axis of the discharge air passage. In another embodiment arranged in the discharge air passage beneath the air turbulence means is a fat filter which can be removed from the discharge air passage and which performs the function of a preliminary filter.

In another development of the preparation apparatus according to the invention arranged within the discharge air passage downstream of the plasma chamber in the flow direction is a filter device, preferably an activated carbon filter. The filter device is preferably used to filter out of the discharge air possible remaining residual constituents which could not be converted within the plasma chamber. The filter used is preferably an activated carbon filter which achieves a preferably high level of efficiency in filtering molecular constituents within a discharge air flow. In addition, making the filter device in the form of a activated carbon filter provides that ozone which possibly occurs within the plasma chamber and which leaves the plasma chamber with the cleaned discharge air flow is passed into the activated carbon filter, bound there and converted into harmless constituents. The transfer of ozone into the filter device further provides for self-cleaning of the activated carbon filter. In that way the service lives of the filter device which is connected downstream of the plasma chamber is improved, in comparison with conventional filter devices, in such a way that the service lives achieved with the apparatus according to the invention are a multiple of the usual service lives. In an embodiment of the invention fragrance pads can be associated with the activated carbon filter, that give off a fragrance to the discharge air as the air passes.

In a development the apparatus according to the invention is distinguished by an electronic control unit for controlling at least the device for controlling the discharge air and the fan in the discharge air passage and preferably further for controlling the cooking temperature and/or cooking times in the respective accommodating compartments. The control unit is used to actuate in particular the individual discharge air and feed air flaps of the control device for the discharge air so that the accommodating compartments are sealingly closed off during preparation of the foodstuffs. The electronic control unit includes a series of sensors like for example contact sensors which detect whether an accommodating container is inserted into or removed from a respective accommodating compartment. The sensor unit further includes preferably a plurality of temperature sensors for monitoring for example the discharge air temperature at various portions of the discharge air passage. In addition, pressure sensors for detecting the absolute pressure in the appliance housing are provided in various regions of the latter. Besides control of the discharge air function by way of the discharge air passage at the apparatus closed-loop control of the temperature within the accommodating compartments of the first and second accommodating devices is effected by means of the electronic control unit, involving therefore actuation of the heating devices associated with the accommodating compartments for the foodstuffs. Furthermore preferably the drive unit, by means of which the drum of the second accommodating device is caused to rotate, is also connected in signal-conducting relationship to the electronic control unit. By means of the control device which is controllable by way of a display arranged at the appliance housing, the cooking times and cooking temperatures can be individually set or adjusted in accordance with the respective nature of the foodstuff to be prepared.

Preferably the accommodating containers which can be inserted into the accommodating compartments are separated from the respectively associated heating devices by means of screening plates, wherein the screening plates preferably have a hole arrangement of a hole size matched to the heating power of the heating devices. The influence of the radiant heat of the heating elements of the heating device on the foodstuffs to be prepared is influenced by means of the screening plates. Therefore only a predetermined part of radiant heat can pass directly into the region of the accommodating compartment and act on the foodstuffs there, through the hole arrangement in the screening plates. Preferably the screening plates at the first accommodating device form all surface regions of the walls delimiting the accommodating compartments. In particular the screening plates constitute regions of the lateral, upper and lower walls of the mutually juxtaposed accommodating compartments. The lateral walls are preferably oriented in plane-parallel relationship with each other. In a preferred embodiment the lateral screening plates have the number of holes over approximately half their height, starting from the underside of the lateral walls. This therefore provides an equilibrium between the radiant heat acting on the foodstuffs and the free convection which is formed by the heat within the accommodating compartment. In that way the foodstuffs to be prepared, in particular the meat products in the first accommodating device, are cooked uniformly over the entire height and in particular uniform browning of their surface is achieved.

In a preferred configuration of the apparatus according to the invention the heating device, in particular the heating elements thereof, at the first accommodating device is arranged outside the accommodating compartment delimited by the screening plates. The heating device is of such a design that the heating elements for the two accommodating compartments if necessary can be actuated separately or individually by the electronic control unit, thereby avoiding unnecessary heating of the second accommodating compartment.

In a development of the apparatus according to the invention the first accommodating device for the meat products has a substantially V-shaped upper cover region which is adapted to generate in the interior of the first accommodating device a free circulatory flow for gases during the cooking process. Thus within the accommodating compartments of the first accommodating device, a heat build-up in the upper region of the accommodating device can be counteracted. Rather, the inclined configuration of the cover region produces a free circulatory flow within the accommodating compartment, thereby providing for uniform mixing of the temperature and linked thereto a uniform cooking process for the foodstuff in the accommodating container. In addition the upper and lower walls of the accommodating compartment are preferably provided over their entire surface with holes which promote the circulatory flow through the accommodating compartments in a vertical direction. The top region of the first accommodating device has a kind of wedge shape, wherein the wall surfaces of the top, that extend at an angle relative to each other, extend at an angle in a range of about 120° to about 160°.

Preferably the accommodating container of the first accommodating device has below the holder for the meat products a discharge element, preferably an inclined discharge channel, for discharge of liquids out of the accommodating compartment. Any cooking liquid produced in the cooking process therefore does not remain within the accommodating compartment during the cooking process which is taking place, but is passed into a region outside the accommodating compartment. The additional production of fat-bearing and odor-intensive vapors is counteracted in that way so that at least in a subsequent cooking process the liquid from the previous cooking process has not remained in the accommodating compartment and is not heated again. The production of such unwanted vapors is reduced to a minimum by passing the liquid out of the accommodating compartment.

Preferably arranged below the first accommodating device is a liquid catch container corresponding to the discharge element on the accommodating container, which catch container is preferably shielded by means of a heat insulation from the accommodating compartment arranged thereover. The catch container preferably serves as a collecting container for the cooking liquid which occurs for example during a day by virtue of the large number of successive cooking processes. The liquid catch container is adapted to be removable on the appliance housing so that it can be emptied and cleaned at regular intervals. Preferably the catch container is equipped with a microswitch which detects when a predetermined liquid level is reached within the catch container, which possibly makes early emptying of the catch container necessary. The microswitch is coupled to the electronic control unit which, upon actuation of the microswitch, outputs an alarm signal to the display and operating unit. An operator is then informed about the need for cleaning of the liquid catch container.

A development of the invention provides that the heating device of the second accommodating device is arranged within the cylindrical accommodating compartment and is separated by the screening plate extending region-wise and parallel to the wall of the accommodating compartment. Preferably, within the cylindrical accommodating compartment, an equilibrium is achieved between the radiant heat acting by virtue of the heating elements of the heating device and the convection which occurs within the cylindrical accommodating compartment, by means of the screening plate which preferably partially has a hole arrangement. The heating device like also the screening plate extending between the heating device and the drum extends approximately over half the periphery of the cylindrical accommodating compartment. The screening plate preferably has at least one surface region with a hole arrangement, by way of which direct heat radiation on to the drum arranged in the accommodating compartment is ensured. Once again only a part of the radiant heat generated is transmitted directly to the drum by means of the hole. The other part is dissipated through the closed regions of the screening plate along the wall of the cylindrical accommodating compartment of the second accommodating device whereby a heat circulation flow is also formed in the second accommodating device. That provides for improved heat input and thus expedited cooking of the foodstuffs in the drum. In an embodiment arranged beneath the drum-like accommodating container is a crumb tray which avoids parts of the foodstuffs to be prepared coming into contact with the heating device.

Preferably the drum has a cylindrical accommodating chamber delimited by a drum wall which includes a hole arrangement. In particular the peripheral surface of the drum has a uniform hole arrangement, whereby both heat radiation and also a flow of heat can penetrate into the interior of the drum-like accommodating container. Preferably the hole arrangement in the drum wall is arranged displaced with respect to the hole arrangement in the associated screening plate.

In a development of the apparatus according to the invention the drum can be reversibly coupled to and uncoupled from a holder mounted rotatably in the chamber, wherein the holder is rotationally coupled to a drive device. Preferably at its end which can be inserted into the accommodating compartment the drum has at least one latching means which involves in particular a positively locking connection to the holder in the accommodating compartment. The positively locking connection permits the drum to be coupled to and uncoupled from the holder in the accommodating compartment of the second accommodating device as often may be desired.

Preferably the first and/or the second accommodating device is at least region-wise enclosed by a pre-fabricatable insulating portion which is formed from an insulating material which can be adapted to the shape of the respective accommodating device. Preferably the insulating material used is an insulating material which can be put directly into the required shape and by means of which suitably pre-fabricated insulating portions of a stable shape can be produced. The pre-fabricated insulating portions can then be relatively easily arranged around the respective accommodating device and the heating device which is possibly arranged outside the accommodating compartments of the accommodating device. Preferably, the pre-fabricated insulating portions provide for almost complete encapsulation of the accommodating device except for the recesses for the insertion or removal opening for the respective accommodating containers. Preferably the insulating material is an insulating material known by the term “K-Term”. Preferably a temperature difference of about 200° C. between the inside of the insulation and the outside of the insulation can be achieved by means of the insulating portions.

The object of the invention is further attained or further developed in accordance with further aspects of the invention in an apparatus of the kind set forth in the opening part of this specification, by the following advantageous features which are implemented individually or in combination:
a plasma chamber arranged within the appliance housing for cleaning the discharge air from the cooking chamber, the plasma chamber preferably being arranged within the discharge air passage;
provided within the appliance housing or adjacent to the appliance housing is a discharge air passage which extends at least partially in the vertical direction and which can be brought into fluid-conducting communication with the accommodating device, and/or
arranged beneath the accommodating device is at least one catch element for catching liquids which are produced during cooking, in particular oils or fats, which is preferably part of a liquid catch container or cooperates therewith.

The invention is described in greater detail hereinafter by means of a preferred embodiment with reference to the accompanying Figures in which:

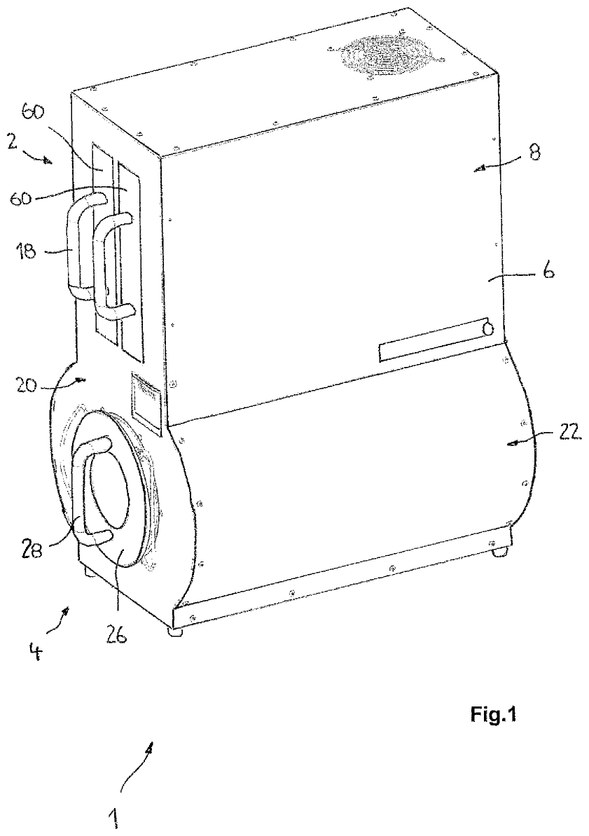

FIG. 1 shows a perspective view of the apparatus according to the invention for heating and/or cooking foodstuffs,

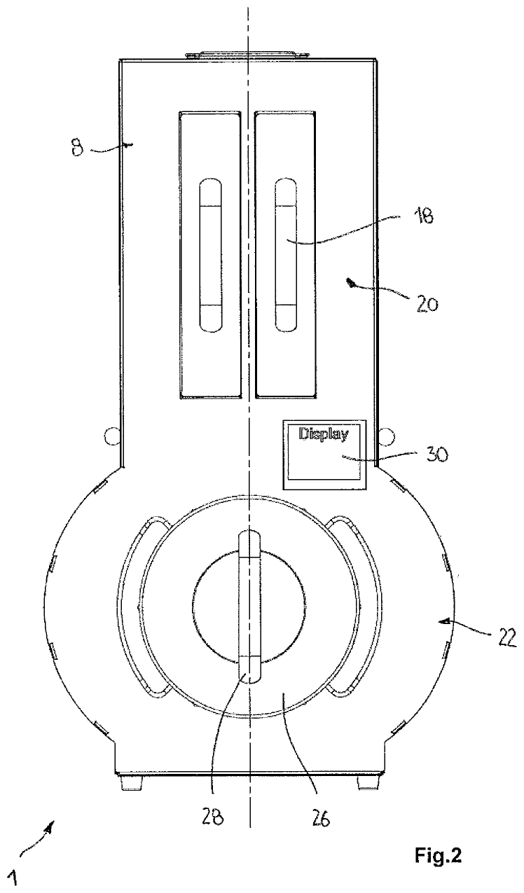

FIG. 2 shows a front view of the apparatus according to the invention as shown in FIG. 1,

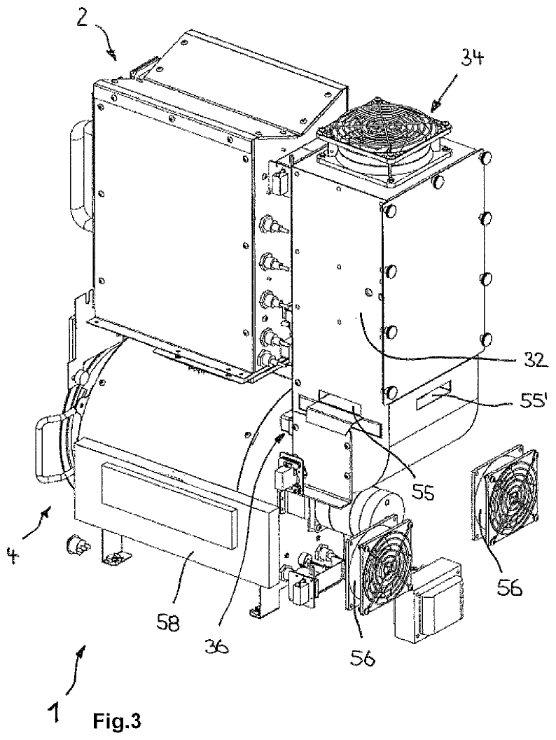

FIG. 3 shows a perspective view of the individual components of the apparatus according to the invention without the appliance housing,

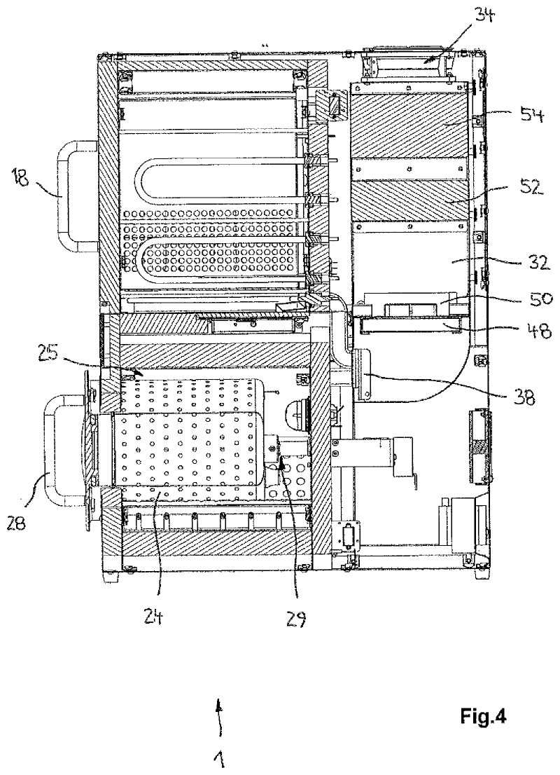

FIG. 4 shows a side view of the apparatus according to the invention in a first sectional plane,

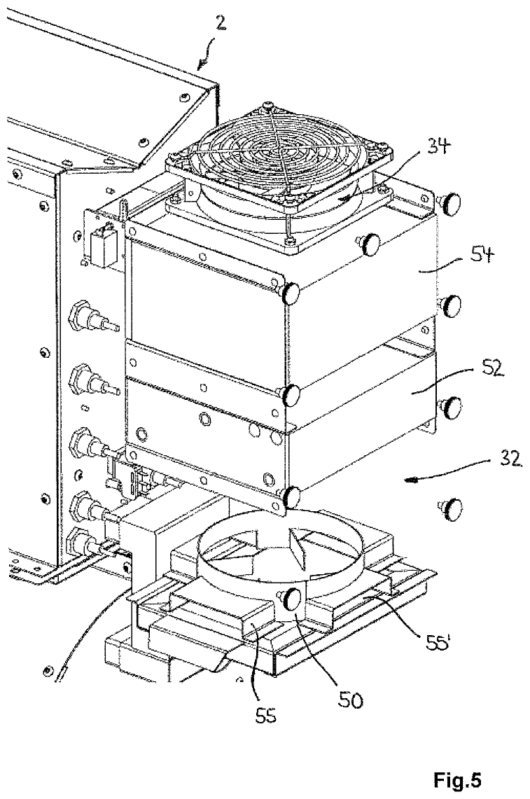

FIG. 5 shows a perspective view of the components arranged within the discharge air passage according to the invention,

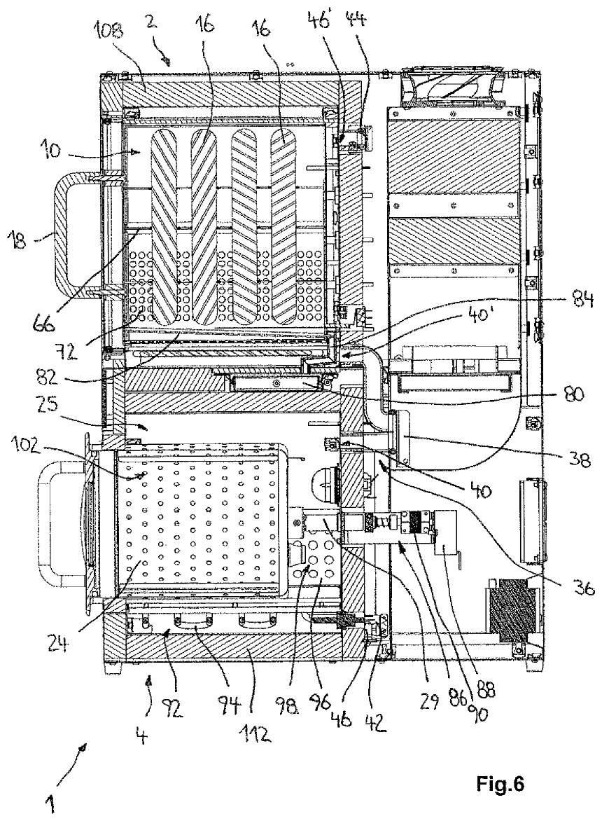

FIG. 6 shows a side view of the apparatus according to the invention in a second sectional plane,

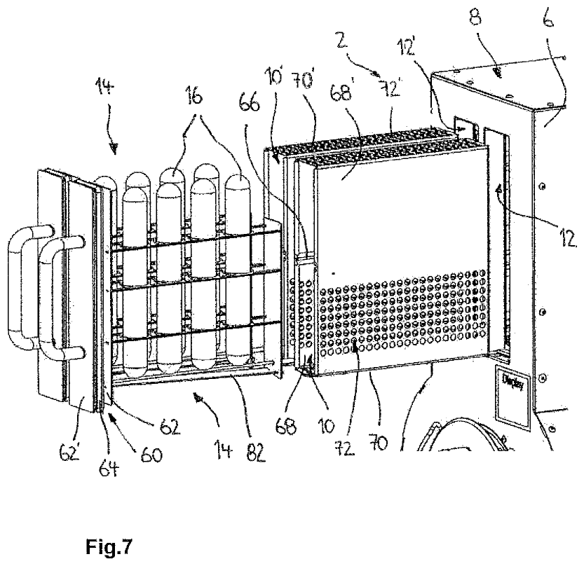

FIG. 7 shows a perspective view of the accommodating containers for the meat products, which are removed from the first accommodating device, and

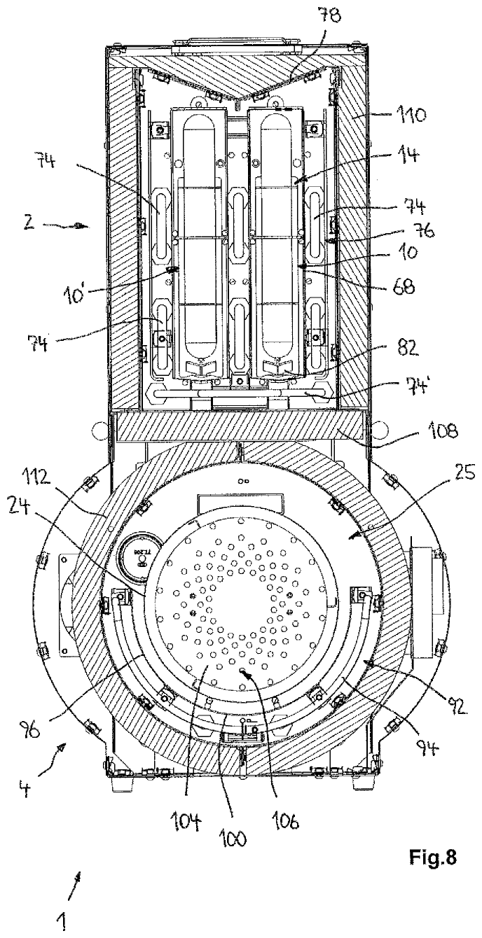

FIG. 8 shows a front view of the apparatus according to the invention in section.

FIG. 1 shows an apparatus 1 for heating and/or cooking foodstuffs which has a first accommodating device 2, in particular for meat products, and a second accommodating device 4 for frozen products like for example French fries or croquettes. The apparatus according to the invention is in the form of a combi-appliance, with which preferably simultaneous preparation of different foodstuffs is possible. The apparatus 1 includes an appliance housing 6, within which the first and second accommodating devices 2, 4 are integrated.

The accommodating device 2, also referred to as and in the form of a grill device 2, is arranged above the second accommodating device 4 in the present embodiment. The first accommodating device 2 or grill device is arranged in the upper cuboidal portion 8 of the appliance housing 6. The grill device 2 has two accommodating compartments 10, 10′ accessible by way of openings 12, 12′ (FIG. 7) in the appliance housing 6. The accommodating device for the meat products is adapted to receive two accommodating containers 14, 14′ (FIG. 6). The accommodating containers 14, 14′ with their accommodating means for the sausages 16 shown in the present embodiment are inserted into the accommodating compartments 10, 10′. For handling the accommodating containers 14, 14′ there is provided a respective handle 18 which projects at the front of the appliance housing at 20.

Arranged beneath the first accommodating device 2 in the form of the grill device, in the lower cylindrical portion 22, is the second accommodating device 4, also referred to as and in the form of a cooking device for frozen products like French fries or croquettes. The second accommodating device 4 or cooking device includes a cylindrical drum 24 (FIG. 4) which is mounted rotatably in a correspondingly designed accommodating compartment 25, of which the cover 26 can be seen in FIG. 1. Arranged on the cover 26 there is also a handle 28 with which the drum 24 can be connected to or disengaged from a holder 29 (FIG. 4) in the accommodating compartment 25 of the apparatus 1, as described hereinafter, for removal of the drum 24 and for insertion thereof respectively, so that the drum 24 can be removed from the second accommodating device 4 or inserted into same again.

FIG. 2 shows a front view of the apparatus 1 according to the invention, on which a digital display and operating device 30 is arranged. By means of the display device 30, operation of the individual accommodating devices is implemented or by way of the display suitable settings of the accommodating devices 2, 4 or any alarm signals are displayed or reproduced. A core aspect of the present invention is sealing closure of the accommodating compartments 10, 10′, 25 which receive the respective accommodating containers 14, 14′, 24 so that each accommodating compartment 10, 10′, 25 is in the form of an outwardly closed-off cooking chamber for the foodstuff to be heated. In particular the accommodating container 14, 14′ of the first accommodating device 2 and the accommodating container 24 of the second accommodating device 4 have closure or sealing elements (not shown in FIGS. 1 and 2) like for example the sealing lip arranged at the cover 26 of the drum 24.

FIG. 3 shows a perspective view of the apparatus 1 without the appliance housing and thus the individual components thereof arranged in its interior. Accordingly, besides the accommodating devices 2, 4 for preparation of the foodstuffs, it is possible to see the aspect which is further an essential aspect of the invention. Arranged within the appliance housing 6 is a discharge air passage 32 which can be fluid-conductingly coupled to the accommodating compartments of the accommodating devices 2, 4 and by way of which the preparation vapors which occur during the cooking or grilling process in the form of waste or discharge air are to be discharged from the accommodating compartments 10, 10′, 25 into the environment. In order to promote discharge of the discharge air, arranged at the upper end of the discharge air passage 32 is a fan 34, by means of which the air is sucked out of the accommodating compartments 10, 10′, 25 for the accommodating containers 14, 14′, 24. Associated with the discharge air passage 32 is a device 36 for controlling the air to be discharged from the accommodating compartments 10, 10′, 25. By means of the discharge air control device 36, at least during operation of the grill device 2 and the cooking device 4, the fluid-conducting communication with the discharge air passage 32 is interrupted so that no heat can issue from the cooking chambers during the cooking or grilling process.

In a preferred embodiment of the invention the discharge air control device 36 has a controllable discharge air flap 38, by means of which an outlet opening 40, 40′ (FIG. 6) connected to the discharge air passage at a respective accommodating compartment 10, 10′, 25 is opened or closed. In addition, associated with the accommodating compartments 10, 10′ of the first accommodating device 2 and the accommodating compartment 25 of the second accommodating device 4 is a respective feed air flap 42, 44 which is also actuated by way of the discharge air control device 36. The feed air flaps 42, 44 are adapted to open or close a corresponding inlet opening 46, 46′ at the respective accommodating devices 2, 4 so that, when the inlet opening is opened, fresh air can flow into the respective accommodating compartment 10, 10′, 25.

FIG. 4 shows a sectional view through the apparatus 1 according to the invention and is intended to clearly show in particular the structure in the region of the accommodating devices 2, 4 and the discharge air passage 32. Arranged in the discharge air passage 32 directly downstream of the discharge air flap 38 arranged in the passage 32 is a fat filter 48, with which pre-filtering of the air sucked out of the accommodating compartments 10, 10′, 25 is effected. Connected immediately downstream of the fat filter 48 is an air turbulence means 50 which mixes the discharged air so that a uniform temperature level is produced over the entire cross-section of the discharge air passage 32. Arranged above the air turbulence means 50 is a plasma chamber 52 for cleaning the discharge air. Ionization of the discharge air passed through the plasma chamber is effected therein whereby the fat and odor molecules entrained with the discharge air are broken down. Connected downstream of the plasma chamber 52 in the flow direction of the discharge air is a filter device 54, in particular an activated carbon filter, with which residual unwanted constituents which have remained in the discharge air are filtered out.

As can also be seen from FIG. 5 in combination with FIG. 3 the air turbulence means 50 is further adapted for adding ambient air from the interior of the housing 6 whereby the temperature within the discharge air passage 32 can be so adapted that it can be reduced below a maximum temperature which is predetermined for operation of the plasma chamber 52. In an embodiment of the invention the air turbulence means 50 is connected in fluid-conducting relationship to a radially oriented bypass passage 55, 55′. A connection to the interior of the housing 6 is afforded by way of the bypass passages 55, 55′. In order to be able to adapt the ratio of the addition to ambient air, arranged rearwardly on the housing 6 are two fans 56, 56′ (FIG. 3), by means of which the feed of air into the appliance housing and thus the pressure conditions in the appliance housing can be adapted. As can further be seen from FIG. 3 there is an electronic control unit for controlling at least the discharge air control device 36 and the fans 34, 56, 56′ on the appliance housing 6 and further for controlling the cooking and grilling temperatures and/or cooking and grilling times at the respective accommodating devices 2, 4. The control unit 58 is coupled in signal-conducting relationship to the operating and display device 30 on the appliance housing front 20.

FIGS. 6 through 8 show the more detailed configuration of the accommodating device 2 in the form of the grill device and the second accommodating device 4 in the form of the cooking device. The first accommodating device 2 is a grill device for meat products, wherein the accommodating containers 14, 14′ in the illustrated embodiment have receiving means for sausages 15. In an embodiment which is not shown here the accommodating container can also be adapted to receive pieces of meat like for example cutlets. The grilling times are then to be adapted according to the meat product to be prepared. As can be seen from FIGS. 6 through 8 the sausages 16 are disposed vertically within the accommodating container 14, 14′. For closing the openings 12, 12′ of the accommodating compartments 10, 10′ at the first accommodating device 2 there is a double-wall closure portion 60 made from an inner plate 62 and an outer plate 62′ which seal with different regions of the openings. In addition provided at the outer plate 62′ is a peripherally extending sealing element 64 in the form of a silicone seal. The accommodating containers 14, 14′ are accommodated by way of guide grooves 66 in the wall of the accommodating compartment 10, 10′, the wall of the accommodating compartment being formed from screening plates 68, 68′. The wall formed from the screening plates 68, 68′, 70, 70′ of the accommodating compartments, being shown as an exploded view in FIG. 7, is usually fixedly integrated within the appliance housing 6.

As FIG. 7 shows the screening plates 68 through 70′ have a hole arrangement 72, 72′ in predetermined surface regions. The hole arrangement in the screening plates 68 through 70′ serves in particular to distribute uniformly within the accommodating compartments 10, 10′, the heat which is generated within the accommodating compartments and which is generated by a plurality of heating elements 74, 74′ of a heating device 76 of the first accommodating device 2. The hole arrangement 72, 72′ provides an equilibrium between the radiant heat delivered by the heating elements 74, 74′ and the convection heat within the accommodating device 2.

Moreover in an embodiment of the invention the first accommodating device 2 has an upper V-shaped cover region 78. The wall surfaces forming the cover region extend in particular at an angle in the region of about 120° C. to about 160° C. relative to each other. By way thereof a free circulatory flow is formed within the accommodating device 2. In the illustrated embodiment the heating elements 74 are respectively arranged laterally relative to the accommodating compartments and at least one heating element 74′ extends beneath the accommodating compartments 10, 10′ of the first accommodating device. Arranged beneath the first accommodating device is a liquid catch container 80 used as a collecting container for the liquid which is produced during grilling of the meat products. To catch the liquid produced upon grilling each accommodating container 14, 14′ has a discharge element 82 which extends in the longitudinal direction of the accommodating container and which is in the form of an inclined discharge channel. Each accommodating container 14, 14′ has such a discharge element 82 which is in the form of the inclined discharge channel and communicates with the liquid catch container by way of a discharge passage 84. The catch container 80 is also shielded by way of an insulating element relative to the accommodating device 2 which is above it to prevent heating of the liquid which is caught within the catch container 80.

The second accommodating device 4 has a cylindrical accommodating compartment 25, within which is accommodated the accommodating container 24 in the form of the cylindrical drum. It will be apparent in the FIG. 6 embodiment that the accommodating container 24 can be reversibly coupled by way of the holder 29 to a drive device 86, which generates a rotary movement of the accommodating container 24 about its longitudinal axis. The drive device 86 includes at least one drive motor 88 and a transmission 90. A heating device 92 having at least one heating element 94 is arranged within the accommodating compartment 25. The heating element 94 extends over the entire length of the accommodating compartment and over approximately half the periphery of the accommodating compartment, with the heating element being laid in a spiral. Arranged between the heating element and the accommodating container is a screening plate 96 which has two lateral surface regions with hole arrangements 98. The central surface region 100 is closed and in particular is in the form of a crumb tray for catching pieces of product which come out of the accommodating container 24. The accommodating container 24 in the form of the cylindrical drum has a peripheral surface completely provided with hole arrangements 102. In addition a part of the end wall 104 of the accommodating container 24 is perforated with holes 106. As can be seen in particular from FIGS. 6 and 8 the first and second accommodating devices 2, 4 are enclosed by an insulation. The insulation is formed in particular by pre-fabricated insulating portions 108, 110, 112 comprising workable insulating material. The insulating portions almost completely fill the accommodating devices 2, 4 as far as the region of the openings of the respective accommodating devices 2, 4.

Similar or identical components are denoted by the same references.

### LIST OF REFERENCES

1 apparatus
2, 4 accommodating device
6 appliance housing
8 portion
10, 10′ accommodating compartment
12, 12′ opening
14, 14′ accommodating container
16 sausage
18 handle
20 appliance housing front
22 portion
24 cylindrical drum/accommodating container
25 accommodating compartment
26 cover
28 handle
29 holder
30 operating and display device
32 discharge air passage
34 fan
36 control device for discharge air
38 discharge air flap
40, 40′ outlet opening
42, 44 feed air flap
46, 46′ inlet opening
48 fat filter
50 air turbulence means
52 plasma chamber
54 filter device
55, 55′ bypass passage
56, 56′ fan
58 control unit
60 closure portion
62, 62′ inner plate and outer plate
64 sealing element
66 guide groove
68, 68′ screening plate
70, 70′ screening plate
72, 72′ hole
74, 74′ heating element
76 heating device
78 cover region
80 catch container
82 discharge element
84 discharge passage
86 drive device
88 drive motor
90 transmission
92 heating device
94 heating element
96 screening plate
98 hole
100 crumb tray
102 hole
104 end wall
106 hole
108, 110 insulating portion
112 insulating portion

1. An apparatus for heating or cooking food, the apparatus comprising:
an appliance housing with at least one accommodating device, wherein the accommodating device comprises one or more accommodating compartments which are accessible by way of at least one opening in the appliance housing, and an accommodating container for the food which communicates with the respective accommodating compartment and can be inserted into and removed from the accommodating compartment; and
a heating device associated with the accommodating device and comprising one or more heating elements,
wherein the accommodating container has a closure portion for sealingly closing the respective accommodating compartment and an outwardly substantially closed cooking chamber for the food to be heated.

2. The apparatus of claim 1, wherein the at least one accommodating device comprises a first accommodating device adapted for heating/cooking meat products and a second accommodating device adapted for heating/cooking frozen products.

3. The apparatus of claim 2, wherein the first accommodating device comprises two accommodating compartments with insertion cassettes which are configured to be inserted into and removed from the accommodating compartments and having respective accommodating means for a plurality of meat products and/or the second accommodating device has an accommodating compartment with a drum configured to be inserted into and removed from the accommodating compartment.

4. The apparatus of claim 1, further comprising at least one discharge air passage coupled in fluid-conducting relationship to an accommodating device and having a fan for discharge of preparation vapors produced during cooking and a plasma chamber for cleaning discharge air from the cooking chamber.

5. The apparatus of claim 4, further comprising a device associated with the discharge air passage for controlling discharge air to be discharged at least from the accommodating compartment.

6. The apparatus of claim 5, wherein the device for controlling the discharge air has at least one actuable discharge air flap by means of which at least one outlet opening connected to the discharge air passage on the accommodating compartment is opened and closed.

7. The apparatus of claim 5, further comprising an air turbulence means arranged within the discharge air passage and connected upstream of the plasma chamber for mixing the discharge air, and at least one fan provided in a wall of the appliance housing for introducing ambient air into the appliance housing.

8. The apparatus of claim 4, further comprising a filter arranged within the discharge air passage downstream of the plasma chamber.

9. The apparatus of claim 5, further comprising an electronic control unit for controlling the device for controlling the discharge air, the fan in the discharge air passage, and cooking temperature and/or cooking times in the one or more accommodating compartments.

10. The apparatus of claim 2, wherein the accommodating containers are separated from the respective heating devices by means of screening plates, and wherein the screening plates have a hole arrangement of a hole size matched to the heating power of the heating devices.

11. The apparatus of claim 10, wherein the heating device of the first accommodating device is arranged outside the accommodating compartment delimited by the screening plates.

12. The apparatus of claim 2, wherein the first accommodating device for the meat products has a substantially V-shaped upper cover region which is adapted to generate a circulatory flow for gases during cooking in the interior of the first accommodating device.

13. The apparatus of claim 2, wherein the accommodating container of the first accommodating device comprises a discharge element for discharge of liquids out of the one or more accommodating compartments.

14. The apparatus of claim 13, further comprising a liquid catch container arranged below the first accommodating device and communicating with the discharge element on the accommodating container, wherein the liquid catch container is insulated from the accommodating compartment arranged thereover.

15. The apparatus of claim 10, wherein the heating device of the second accommodating device is arranged within a cylindrical accommodating compartment and is separated by the screening plate extending region-wise and parallel to a wall of the accommodating compartment.

16. The apparatus of claim 3, wherein the drum defines a cylindrical accommodating chamber delimited by a drum wall which has a hole arrangement.

17. The apparatus of claim 1, wherein the drum is reversibly coupled to a holder mounted rotatably in the chamber, the holder being rotationally coupled to a drive device.

18. The apparatus of claim 2, wherein the first and/or the second accommodating device is enclosed by an insulating portion formed from an insulating material.

19. The apparatus of claim 4, further comprising a plasma chamber arranged within the appliance housing for cleaning discharge air from the cooking chamber.

20. The apparatus of claim 1, further comprising a discharge air passage provided within the appliance housing or adjacent to the appliance housing, and which extends at least partially in the vertical direction, and which is configured to be brought into fluid-conducting communication with the accommodating device.

21. The apparatus of claim 1, further comprising at least one catch element beneath the accommodating device for catching liquids produced during cooking.
